(19) United States
(12) Patent Application Publication
(10) Pub. No.: US 2009/0019225 A1
(43) Pub. Date: Jan. 15, 2009

(54) INFORMATION PROCESSING APPARATUS AND INFORMATION PROCESSING SYSTEM

(75) Inventor: Seiji MAEDA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/038,467

(22) Filed: Feb. 27, 2008

(30) Foreign Application Priority Data
Jul. 11, 2007 (JP) 2007-182618

(51) Int. Cl. G06F 12/00

(52) U.S. Cl. 711/125; 711/E12.001

(57) ABSTRACT

With respect to memory access instructions contained in an internal representation program, an information processing apparatus generates a load cache instruction, a cache hit judgment instruction, and a cache miss instruction that is executed in correspondence with a result of a judgment process performed according to the cache hit judgment instruction. In a case where the internal representation program contains a plurality of memory access instruction having a possibility of using mutually the same cache line in a cache memory when mutually different cache lines in a main memory are accessed, the information processing apparatus generates a combine instruction instructing that judgment results of the judgment processes that are performed according to the cache hit judgment instruction should be combined into one judgment result. The information processing apparatus outputs an output program that contains these instructions that have been generated.

### CROSS-REFERENCE TO RELATED APPLICATIONS

This application is based upon and claims the benefit of priority from the prior Japanese Patent Application No. 2007-182618, filed on Jul. 11, 2007; the entire contents of which are incorporated herein by reference.

### BACKGROUND OF THE INVENTION

1. Field of the Invention

The present invention relates to an information processing technique for converting a first program into a second program written in a machine language that is interpretable by a processor and also an information processing technique that uses a cache memory being operable to temporarily store therein data stored in a main memory.

2. Description of the Related Art

Conventionally, commonly-used processors are able to execute programs (i.e., object codes) that are written in a machine language specified by an instruction set architecture for each processor. On the other hand, in many cases, programmers perform programming processes by using a high-level programming language such as the C language that is easier to understand than machine languages. Thus, before a program is executed by a processor, it is necessary to convert the program written in a high-level programming language into object codes, by using a program converting means such as a compiler. Also, in some situations, object codes for a processor are converted into object codes for another processor, by using a program converting means such as a binary translator. For example, JP-A 2002-536712 (KOHYO) discloses a technique for converting, when a program is to be executed, object codes for a processor into object codes for another processor.

Further, recently, some computers include a temporary storage device such as a cache memory or a local memory that is provided between the processor and the main memory and has a smaller capacity but has a higher performance of data supply than the main memory, so that it is possible to make the gap smaller between the performance of data processing of the processor and the performance of data supply of the main memory. In such a computer, it is possible to enhance the performance of data supply and to make use of the performance of data processing of the processor by temporarily storing the data stored in the main memory into the temporary storage device. However, because such a temporary storage device has a smaller capacity than the main memory, the temporary storage device is not able to store therein all of the data stored in the main memory. Thus, it is necessary to replace, as necessary, the data stored in the temporary storage device, according to the data access of the processor, or the like. The data transfer between the cache memory and the main memory is performed automatically. However, the data transfer between the local memory and the main memory is performed according to an explicit command from a program to a data transfer device.

The cache memory and the main memory are divided into partial memory areas called cache lines. Between the cache memory and the main memory, the data is replaced in units of cache lines. When the processor access data stored in the main memory, a cache hit judgment process is performed so as to check to see if the data stored in the main memory is temporarily stored in the cache memory (This situation is known as a cache hit). In the cache hit judgment process, in a case where it has been judged that the data to be accessed is not temporarily stored in the cache memory, in other words, in a case where a cache miss has occurred, the data in the cache line within the main memory that contains the data to be accessed is transferred to the cache line within the cache memory. In this situation, if there is no free space in the cache lines in the cache memory, cache lines that are currently used and are temporarily storing therein other data need to be re-used. As a result, the data that has been stored in the cache memory will be replaced with some other data. Also, in a case where the data in the cache line that will be re-used has been changed, the data stored in the cache line will be transferred to the main memory before the cache line are re-used.

In the configuration described above, for example, when pieces of data that are respectively stored in two cache lines (hereinafter, “the cache line A” and “the cache line B”) in the main memory are accessed, there is a possibility that mutually the same cache line in the cache memory (e.g., “a cache line X”) may be used. First, when the data (hereinafter, “the data A”) stored in the cache line A in the main memory is accessed, the data A is transferred to the cache line X in the cache memory. Secondly, when the data (hereinafter, “the data B”) stored in the cache line B in the main memory is accessed, because the data A is temporarily stored in the cache line X in the cache memory, a cache miss occurs, and the data B is transferred to the cache line X in the cache memory. Let us discuss a situation where, for example, the data A stored in the cache line A and the data B stored in the cache line B in the main memory are accessed alternately. In this situation, a cache miss occurs every time, and the data A and the data B are repeatedly transferred between the main memory and the cache memory.

In other words, in the conventional cache memory, in a case where mutually the same cache line in the cache memory is used when mutually different cache lines in the main memory are accessed, a cache miss occurs every time the mutually different cache lines in the main memory are accessed alternately. As a result, there is a possibility that a phenomenon called thrashing may occur in which the processing speed is lowered by the frequent cache miss. In this situation, because the data transfer is repeatedly performed between the main memory and the cache memory, a problem arises where the performance of data supply of the memories is degraded.

### SUMMARY OF THE INVENTION

According to one aspect of the present invention, an information processing apparatus includes a program converting unit that converts a first program containing at least one instruction into a second program executable by a first information processing apparatus that includes a processor, a main memory, and a cache memory, the processor having a register operable to temporarily store data used while a program is executed, the main memory being divided in units of cache lines and being operable to store a plurality of pieces of the data into first cache lines that respectively correspond to addresses of the pieces of data, and the cache memory being divided in units of cache lines and in which at least one of second cache lines is used while the data is accessed; and an output unit that outputs the second program, wherein the program converting unit includes: a first instruction generating unit that generates a load cache instruction that represents an instruction to transfer to the register, stored data stored in at least one of the second cache lines used in correspondence with the first cache lines storing the data, with respect to a memory access instruction that is an instruction contained in the first program and represents an instruction to access to the data; a second instruction generating unit that generates a cache hit judgment instruction that represents an instruction to judge whether the data is stored in at least one of the second cache lines being used in correspondence with the first cache lines storing the data, with respect to the memory access instruction; and a third instruction generating unit that generates a combine instruction instructing that judgment results obtained according to the cache hit judgment instructions generated with respect to the memory access instructions are combined into one judgment result, when the first program contains a plurality of memory access instructions having a possibility of using a mutually same second cache line while pieces of the data stored in mutually different first cache lines are accessed.

According to another aspect of the present invention, an information processing apparatus includes a processor having a register operable to temporarily store data used while a program is executed; a main memory that is divided in units of cache lines and is operable to store a plurality of pieces of the data into first cache lines that respectively correspond to addresses of the pieces of data; a local memory that is divided in units of cache lines and in which at least one of second cache lines is used while the data is accessed; a transfer unit that transfers the data stored in the main memory to the local memory; and a cache data controlling unit that performs a judgment process of judging whether the data is stored in the local memory when the processor accesses the data while executing the program, and also performs, before completing the judgment process, a transfer process of transferring to the register, stored data stored in a memory area within the local memory being used while the data is accessed, wherein the cache data controlling unit performs the judgment process and the transfer process in parallel that are performed with respect to a plurality of pieces of the data, the cache data controlling unit combines results of judgment processes performed with respect to the plurality of pieces of the data into one judgment result, when there is a possibility that a mutually same second cache line may be used while a plurality of pieces of the data stored in mutually different first cache lines are accessed, and the cache data controlling unit causes the transfer unit to transfer the data from the main memory to the local memory according to the combined judgment result, and subsequently performs a second transfer process of transferring the data from the local memory to the register.

According to still another aspect of the present invention, an information processing apparatus includes a processor having a register operable to temporarily store data used while a program is executed; a main memory that is divided in units of cache lines and is operable to store a plurality of pieces of the data into first cache lines that respectively correspond to addresses of the pieces of data; a local memory that is divided in units of cache lines and in which at least one of second cache lines is used while the data is accessed; a program converting unit that converts a first program containing at least one instruction into a second program that is executable by the processor; and a cache data controlling unit that performs a judgment process of judging whether the data is stored in the local memory, when the processor accesses the data while executing the second program, and also performs, before completing the judgment process, a transfer process of transferring to the register, stored data stored in a memory area within the local memory being used while the data is accessed, wherein the program converting unit includes a first instruction generating unit, a second instruction generating unit, and a third instruction generation unit and generates the second program that contains at least a load cache instruction and a cache hit judgment instruction, the first instruction generating unit being operable to generate a load cache instruction that represents an instruction to transfer to the register, stored data stored in at least one of the second cache lines used in correspondence with the first cache lines storing the data; the second instruction generation unit being operable to generate the cache hit judgment instruction that represents an instruction to judge whether the data is stored in at least one of the second cache lines being used in correspondence with the first cache lines storing the data, with respect to a memory access instruction; and the third instruction generating unit being operable to generate a combine instruction instructing that judgment results obtained according to the cache hit judgment instructions generated with respect to the memory access instructions are combined into one judgment result, when the first program contains a plurality of memory access instructions having a possibility of using a mutually same second cache line while pieces of the data stored in mutually different first cache lines are accessed, the cache data controlling unit performs the judgment process and the transfer process in parallel that are performed with respect to a plurality of pieces of the data, the cache data controlling unit combines results of judgment processes that are performed with respect to the plurality of pieces of the data into one judgment result, when there is a possibility that a mutually same second cache line is used while a plurality of pieces of the data stored in mutually different first cache lines are accessed, and the cache data controlling unit causes a transfer unit to transfer the data from the main memory to the local memory according to the combined judgment result, and subsequently performs a second transfer process of transferring the data from the local memory to the register.

### BRIEF DESCRIPTION OF THE DRAWINGS

FIG. 1 is a block diagram illustrating an example of a computer system according to an embodiment of the present invention;

FIG. 2 is a block diagram illustrating an example of a host computer 101;

FIG. 3 is a block diagram illustrating examples of functional configurations realized when a processor 201 executes a program conversion program;

FIG. 4 is a diagram illustrating an example of a target computer 102;

FIG. 5 is a diagram illustrating examples of functions that are realized when a processor 401 executes a cache controlling program stored in a program memory 402;

FIG. 6 is a diagram illustrating an example of a data structure of a main memory address output by the processor 401;

FIG. 7 is a diagram illustrating an example of a local memory 403;

FIG. 8 is a diagram illustrating an example of a main memory 406;

FIG. 9 is a diagram illustrating an example of an internal representation program 305 that is output from an input program analyzing unit 302 shown in FIG. 3;

FIG. 10 is a flowchart of a procedure in a generating process performed by an output program generating unit 303 so as to analyze the internal representation program 305 and to generate an output program 103;

FIG. 11 is a flowchart of a procedure in a process of generating a cache memory access instruction instructing that a single memory access should be performed;

FIG. 12 is a drawing illustrating an example of a cache memory access instruction that has been generated as a result of the process at step S806;

FIG. 13 is a flowchart of a procedure in a process of generating a cache memory access instruction instructing that a plurality of memory accesses should be performed;

FIG. 14 is a drawing illustrating an example of a cache memory access instruction that has been generated as a result of the process at step S804; and

FIG. 15 is a drawing illustrating another example of the cache memory access instruction that has been generated as a result of the process at step S804.

### DETAILED DESCRIPTION OF THE INVENTION

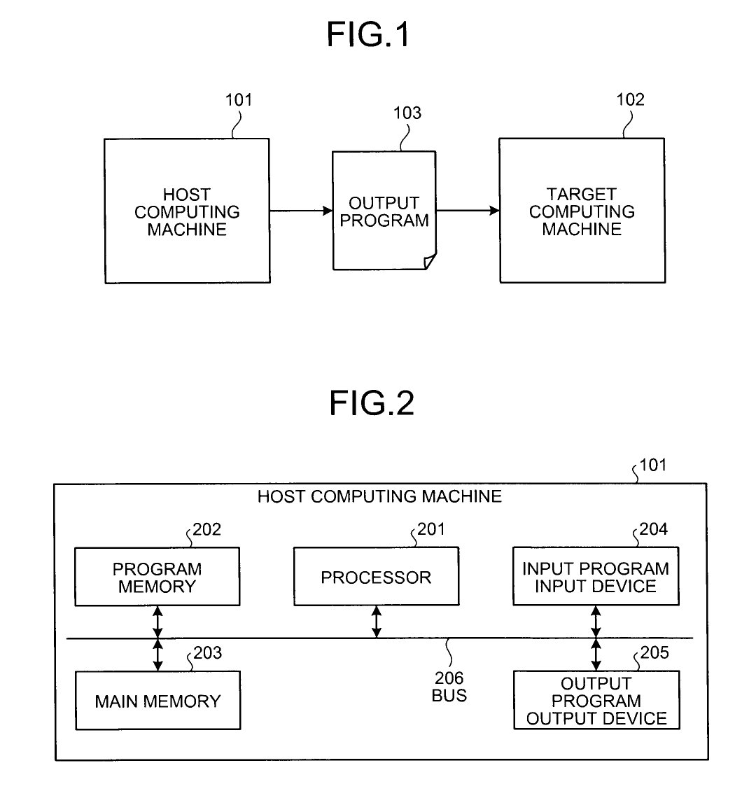

FIG. 1 is a block diagram illustrating an example of a computer system according to an embodiment of the present invention. The computer system includes a host computer 101 and a target computer 102. The host computer 101 generates, from an input program that has been input thereto, an output program 103 written in a machine language that is interpretable by the target computer 102 and outputs the generated output program 103. The target computer 102 executes the output program 103. It is acceptable to output the output program 103 by using a recording medium such as a floppy (a registered trademark) disk or a Compact Disk Recordable (CD-R). Alternatively, another arrangement is acceptable in which the host computer 101 and the target computer 102 are connected to each other by a communication path so that the output program 103 is output via the communication path. Further alternatively, it is acceptable to configure the host computer 101 and the target computer 102 with a single computer.

The input program may be a program that is written in a high-level programming language such as the C language. Alternatively, the input program may be a program that is written in a machine language specified by an instruction set architecture for a predetermined processor.

FIG. 2 is a block diagram illustrating an example of the host computer 101. The host computer 101 includes a processor 201, a program memory 202, a main memory 203, an input program input device 204, an output program output device 205, and a bus 206. The processor 201 is connected to the program memory 202, the main memory 203, the input program input device 204, and the output program output device 205 via the bus 206. The processor 201 executes a program stored in the program memory 202 or a program stored in the main memory 203. The program memory 202 is a memory that is used for storing therein the program executed by the processor 201. The program memory 202 may be configured with, for example, a Read-Only Memory (ROM). The program memory 202 also stores therein a program conversion program used for generating the output program from the input program. The program conversion program will be explained in detail later. The main memory 203 is a memory that is used for storing therein the program executed by the processor 201 and the data used while the program is being executed. The main memory 203 may be configured with, for example, a Random Access Memory (RAM). The input program input device 204 is an input device used for inputting the input program. The input program input device 204 may be configured with, for example, a keyboard, a floppy (a registered trademark) disk drive, or a Compact Disk Read-Only Memory (CD-ROM) drive. The output program output device 205 is an output device used for outputting the output program generated from the input program that has been input by the input program input device 204. The output program output device 205 may be configured with, for example, a floppy (a registered trademark) disk drive or a CD-R drive.

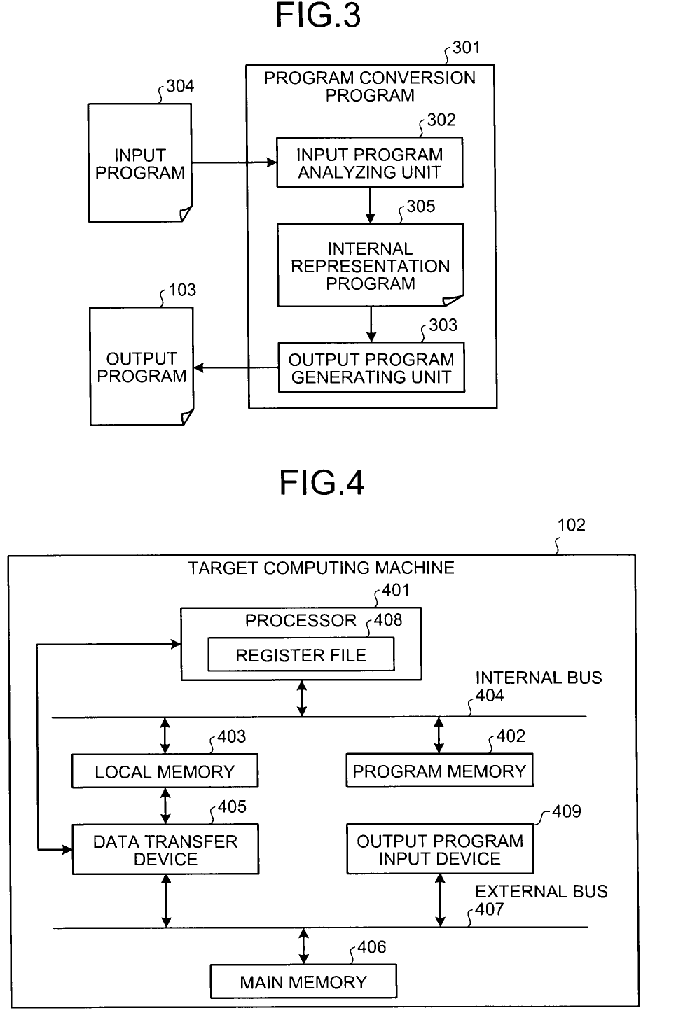

Next, the functions that are realized when the processor 201 included in the host computer 101 executes the program conversion program mentioned above will be explained. FIG. 3 is a block diagram illustrating examples of functional configurations realized when the processor 201 executes the program conversion program. As shown in the drawing, the functions of an input program analyzing unit 302 and an output program generating unit 303 are realized by a program conversion program 301. The input program analyzing unit 302 receives an input of an input program 304 that has been input by the input program input device 204 and analyzes the input program 304 so as to output an internal representation program 305, which is a program written in a data representation format for an internal process. The output program generating unit 303 analyzes the internal representation program 305 that has been output by the input program analyzing unit 302 and generates and outputs the output program 103 that is executable by the target computer 102.

More specifically, with respect to memory access instructions that are instructions contained in the internal representation program and each of which instructs that the data being a process target should be accessed, the output program generating unit 303 generates instructions as shown below and outputs the output program 103 that contains the instructions. It should be noted that the main memory, the local memory, and the register described below are included in the information processing apparatus (i.e., the target computer 102 in the present example) that executes the output program 103. The configurations of the main memory, the local memory, and the register included in the target computer 102 and specific examples of the output program 103 will be described later.

(a) A load cache instruction instructing that the data that is stored in a cache line within the local memory being used in correspondence with the cache line within the main memory corresponding to the address within the main memory (i.e., a main memory address) of the data being the process target should be transferred to the register;

(b) A cache hit judgment instruction instructing that it should be judged whether the data being the process target is stored in the local memory, in other words, whether the data being the process target is stored in the cache line within the local memory being used in correspondence with the cache line within the main memory corresponding to the main memory address;

(c) A combine instruction instructing that, in a case where the internal representation program contains a plurality of memory access instructions having a possibility of using mutually the same cache line within the local memory when the data stored in the different cache line within the main memory is accessed, judgment results of the judgment processes that are performed according to a cache hit judgment instruction should be combined into one judgment result; and

(d) A cache miss instruction instructing that, in a case where a judgment result of the judgment process that is performed according to the cache hit judgment instruction or a judgment result that has been combined according to the combine instruction indicates that the data being the process target is not stored in the cache line as described above, the data being the process target should be transferred from the main memory to the local memory and should be subsequently transferred from the local memory to the register.

FIG. 4 is a diagram illustrating an example of the target computer 102. The target computer 102 includes a processor 401, a program memory 402, a local memory 403, an internal bus 404, a data transfer device 405, a main memory 406, an external bus 407, and an output program input device 409. The processor 401 is connected to the program memory 402 and the local memory 403 via the internal bus 404. The data transfer device 405 is connected to the processor 401 and the local memory 403, and is further connected to the main memory 406 via the external bus 407.

The processor 401 includes a register file 408 and uses it as a storage area for input data and output data that are used in operating processes. The register file 408 includes a plurality of registers. The processor 401 executes a program stored in the program memory 402 or a program stored in the local memory 403. The processor 401 also controls the data transfer device 405. The program memory 402 is a memory that is used for storing therein the program executed by the processor 401. The program memory 402 may be configured with, for example, a Read-Only Memory (ROM). The program memory 402 also stores therein a cache memory controlling program, which is explained later. The local memory 403 is a memory that is used for storing therein the program executed by the processor 401 and the data used while the program is being executed. The local memory 403 may be configured with, for example, a Random Access Memory (RAM). Under the control of the processor 401, the data transfer device 405 transfers a piece of data having a specified size from the local memory 403 to the main memory 406 or from the main memory 406 to the local memory 403. It is acceptable to use, for example, a direct memory access controller (DMA controller) as the data transfer device 405. The output program input device 409 is an input device used for inputting the output program 103 that has been output from the host computer 101 to the local memory 403. The output program input device 409 may be configured with, for example, a keyboard, a floppy (a registered trademark) disk drive, or a CD-ROM drive.

According to the present embodiment, the processor 401 is configured so as not to be able to directly access the main memory 406. However, another arrangement is acceptable in which the processor 401 is able to directly access the main memory. In that situation, it is desirable to have an arrangement in which an access time of the local memory 403 is shorter than an access time of the main memory 406.

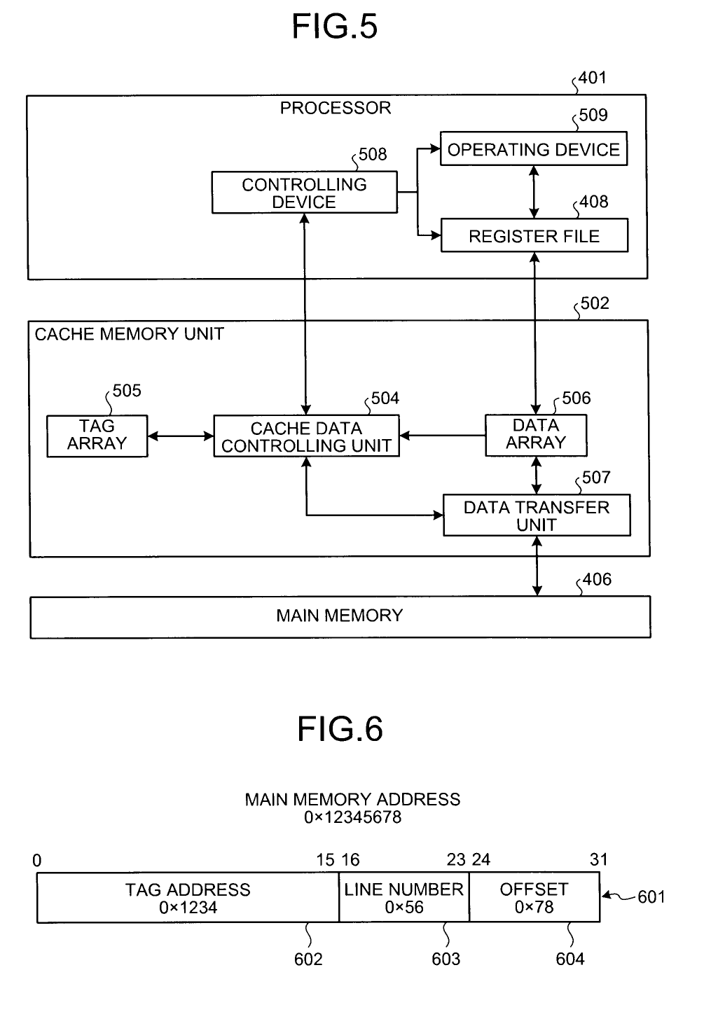

Next, the functions that are realized when the processor 401 executes the cache controlling program described above that is stored in the program memory 402 will be explained. FIG. 5 is a diagram illustrating examples of the functions that are realized when the processor 401 executes the cache controlling program stored in the program memory 402. A cache data controlling unit 504 represents the functions that are realized when the processor 401 executes the cache controlling program. A tag array 505 and a data array 506 are memories that are provided in the local memory 403. The tag array 505 is operable to store therein information used for managing the data in the data array 506. The data array 506 is operable to temporarily store therein the data in the main memory 406. A function of a data transfer unit 507 is realized by the data transfer device 405 described above. A cache memory unit 502 shown in the diagram is configured so as to include the cache data controlling unit 504, the tag array 505, the data array 506, and the data transfer unit 507. The cache memory unit 502 is connected to the processor 401 and the main memory 406 and provides a means used by the processor 401 to access the data in the main memory 406.

The processor 401 described above further includes a controlling device 508 and an operating device 509, in addition to the register file 408. In a case where the processor 401 is to access the data stored in the main memory 406 while executing a program, the controlling device 508 issues an access request to the cache memory unit 502. In that situation, in a case where the processor 401 accesses the main memory 406 so as to write data thereto, the processor 401 outputs data in a register within the register file 408 to the cache memory unit 502. In a case where the processor 401 accesses the main memory 406 so as to read data therefrom, the processor 401 stores (i.e., copies) the data in the cache memory unit 502 into a register within the register file 408. The operating device 509 performs an operating process by using the data stored in the register within the register file 408 and stores a result of the operating process into a register within the register file 408.

In the configuration described above, the cache data controlling unit 504 is connected to the controlling device 508 included in the processor 401 as well as to the tag array 505, the data array 506, and the data transfer unit 507. When having received the access request from the processor 401, the cache data controlling unit 504 controls the access process that is performed in response to the access request. During the access process, the cache data controlling unit 504 manages the data in the data array 506 by using the tag array 505, and also controls the data transfer between the data array 506 and the main memory 406 via the data transfer unit 507.

FIG. 6 is a diagram illustrating an example of a data structure of a main memory address output by the processor 401. A main memory address 601 is configured so as to have 32 bits and includes a tag address 602 having a width of 16 bits, a line number 603 having a width of 8 bits, and an offset 604 having a width of 8 bits. For example, in a case where the main memory address 601 is “0x12345678”, the tag address 602 is “0x1234”, while the line number 603 is “0x56”, and the offset 604 is “0x78”. It is acceptable to use any bit width for the main memory address 601 as long as the address is applicable to a capacity that is larger than the capacity of the main memory 406. For example, in a case where the main memory address 601 has a width of 32 bits, and it is possible to access the main memory 406 in units of one byte, it is possible to apply the main memory address 601 to a capacity of up to a maximum of 4 gigabytes (GB). Also, because the line number 603 has a width of 8 bits, it is possible to use line numbers from “0” to “255”.

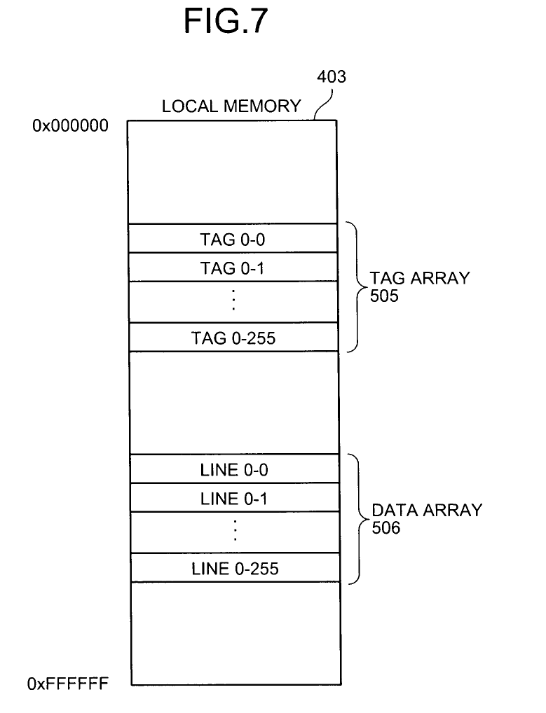

FIG. 7 is a diagram illustrating an example of the local memory 403. In this diagram, the cache lines in the data array and the tags (i.e., management information) in the tag array are each expressed by using the forms of “LINE ‘way number’-‘line number’” and “TAG ‘way number’-‘line number’”, respectively. For example, “LINE 0-255” denotes a cache line of which the way number is “0” and the line number is “255 (0xFF)”.

The local memory 403 stores therein the data array 506 that temporarily stores therein, in correspondence with each of the cache lines, the data in the main memory 406 (the capacity of each cache line is 256 bytes) and the tag array 505 that stores therein, in correspondence with each of the cache lines, the tags (i.e., the management information) of the data stored in the data array 506. Local memory addresses from “0x00000” through “0xFFFFFF” are assigned to the local memory 403. For example, let us assume that the capacity of the local memory 403 is 16 megabytes (MB), and it is possible to specify each piece of one-byte data stored in the local memory 403 by using a different one of the local memory addresses.

The line number in the main memory address is used for identifying one of the cache lines in the data array 506. The tag address in the main memory address is used for identifying data stored in a cache line in the data array 506. An offset is used for identifying in which place of a row of bytes (e.g., the first byte, the second byte, etc.) a piece of data is positioned, among the data (having 256 bytes) stored in a cache line in the data array 506.

The number of cache lines included in the data array 506 is equal to the number of tags included in the tag array 505. To keep the explanation simple, the data array 506 and the tag array 505 each have one way in FIG. 7; however, it is acceptable to configure the data array 506 and/or the tag array 505 so as to have a plurality of ways.

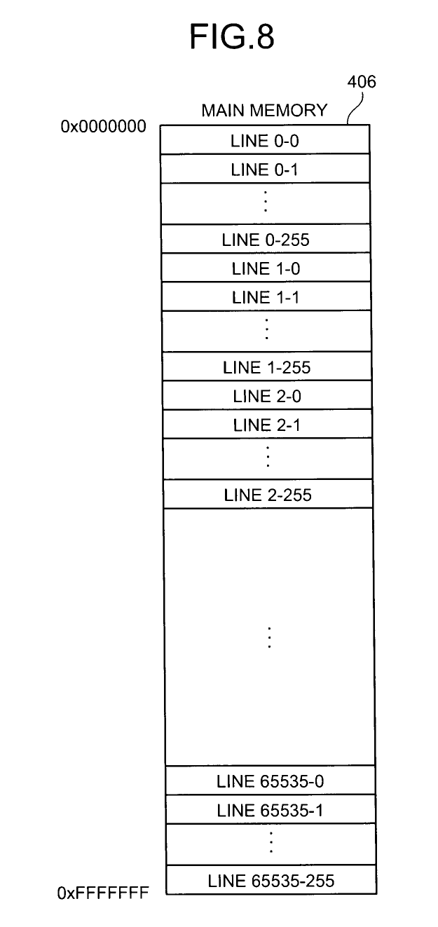

FIG. 8 is a diagram illustrating an example of the main memory 406. The main memory 406 is divided in units of cache lines. Also, the cache lines are organized into groups, so that each group has as many cache lines as the number of cache lines included in the data array 506 in the local memory 403. To each of the cache lines included in the main memory 406 shown in FIG. 8, a cache line number indicating “a group number—a cache line number” is assigned. When an access is made to one of the cache lines in the main memory 406, one of the cache lines in the data array 506 having assigned thereto a cache line number that is equal to the cache line number assigned to the cache line in the main memory 406 will be used. Accordingly, for example, in a case where accesses are made to the cache line “0-0”, the cache line “1-0”, the cache line “2-0”, and the cache line “65535-0” in the main memory 406, the cache line “0-0” in the data array 506 will be used for each of all these accesses.

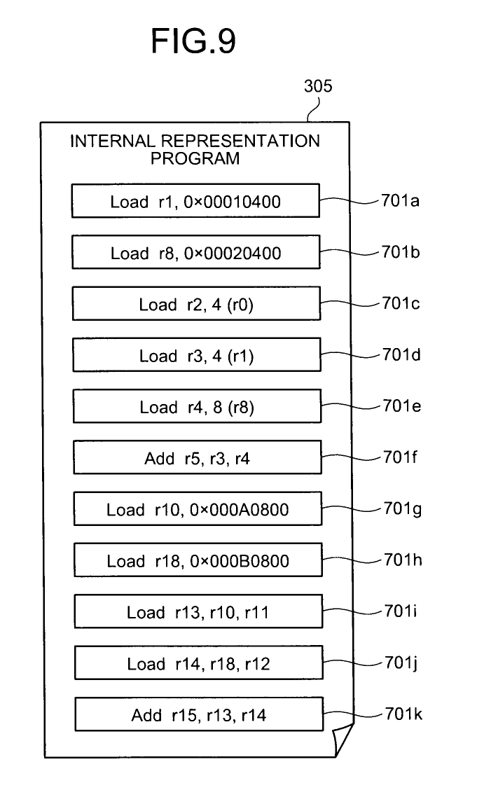

FIG. 9 is a diagram illustrating an example of the internal representation program 305 that is output from the input program analyzing unit 302 shown in FIG. 3. The internal representation program 305 contains internal representation codes 701a, 701b, 701c, 701d, 701e, 701f, 701g, 701h, 701i, and 701k. The internal representation codes 701a, 701b, 701g, and 701h are immediate value load instructions instructing that an immediate value should be set into a register. The internal representation code 701a is an instruction instructing that an immediate value “0x00010400” should be loaded into a register r1. The internal representation code 701b is an instruction instructing that an immediate value “0x00020400” should be loaded into a register r8. The internal representation code 701g is an instruction instructing that an immediate value “0x000A0800” should be loaded into a register r10. The internal representation code 701h is an instruction instructing that an immediate value “0x000B0800” should be loaded into a register r18.

The internal representation codes 701c, 701d, and 701e are each an example of a load instruction that uses a first register indirect addressing mode and instructs that data should be loaded into a register from an address in the main memory 406 obtained by adding an offset value to a base address register value. The internal representation code 701c is an instruction instructing that data should be loaded from an address obtained by adding an offset value “4” to the value in a register r0, which is a base address register, and should be set into a register r2. The internal representation code 701d is an instruction instructing that data should be loaded from an address obtained by adding an offset value “4” to the value in the register r1, which is a base address register, and should be set into a register r3. The internal representation code 701e is an instruction instructing that data should be loaded from an address obtained by adding an offset value “8” to the value in the register r8, which is a base address register, and should be set into a register r4. The internal representation codes 701f and 701k are each an example of an instruction instructing that two register values should be added together. The internal representation code 701f is an instruction instructing that the value in the register r3 and the value in the register r4 should be added together and set into a register r5. The internal representation code 701k is an instruction instructing that the value in a register r13 and the value in a register r14 should be added together and set into a register r15.

The internal representation codes 701i and 701j are each an example of a load instruction that uses a second register indirect addressing mode and instructs that data should be loaded, into a register, from an address in the main memory 406 obtained by adding an offset register value to a base address register value. The internal representation code 701i is an instruction instructing that data should be loaded from an address obtained by adding the value in a register r11, which is an offset register, to the value in the register r10, which is a base address register, and should be set into the register r13. The internal representation code 701j is an instruction instructing that data should be loaded from an address obtained by adding the value in a register r12, which is an offset register, to the value in the register r18, which is a base address register, and should be set into the register r14.

The internal representation program 305 is a part of the input program 304 and is also a basic block within a loop. In addition, the output program 103 that stores therein the sequences of the internal representation program 305 is output by the host computer 101 and is executed by the target computer 102.

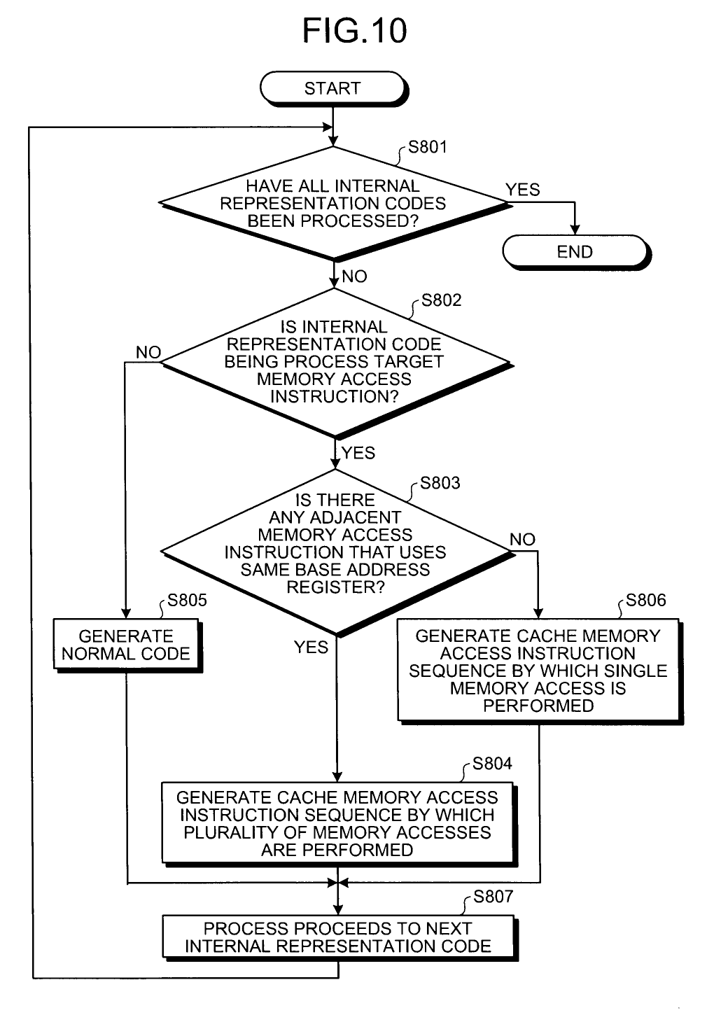

Next, a process that is performed by the host computer 101 according to the present embodiment to output the output program will be explained. As explained above, when the processor 201 included in the host computer 101 as shown in FIG. 2 executes the program conversion program, the functions of the input program analyzing unit 302 and the output program generating unit 303 shown in FIG. 3 are realized. In the following sections, a procedure in a generating process performed by the output program generating unit 303 so as to analyze the internal representation program 305 and to generate the output program 103 will be explained in detail, the internal representation program 305 having been output after the input program analyzing unit 302 analyzes the input program 304 that had been received as an input. FIG. 10 is a flowchart of the procedure in the generating process performed by the output program generating unit 303 so as to analyze the internal representation program 305 and to generate the output program 103.

First, the output program generating unit 303 judges whether all the internal representation codes that are contained in the internal representation program 305 have been processed (step S801). If it is judged that all of the internal representation codes have been processed (step S801: Yes), the generating process is ended. If it is judged that not all the internal representation codes have been processed (step S801: No), the output program generating unit 303 judges whether an internal representation code being a process target is a memory access instruction such as a load instruction (step S802). When the judgment result is in the negative, the output program generating unit 303 generates a normal code (i.e., a code in a machine language) that corresponds to the internal representation code (step S805). In a case where the internal representation code being the process target is a memory access instruction (step S802: Yes), the output program generating unit 303 judges whether there is any internal representation code that is positioned adjacent to the internal representation code being the process target (hereinafter, an “adjacent internal representation code”) and represents a memory access instruction that causes an access to a cache line in the main memory 406 that is different from the one accessed by the internal representation code being the process target and has a possibility of, when accessing the data, using the same cache line in the data array 506 as the internal representation code being the process target (step S803). In other words, the output program generating unit 303 judges whether the memory access instructions that cause accesses to the mutually different cache lines in the main memory 406 include a plurality of memory access instructions having a possibility of causing accesses to mutually the same cache line in the data array 506.

In this situation, the “adjacent internal representation code” satisfies one of the following conditions (a), (b), and (c):

(a) An internal representation codes that is contained in the same basic block within the internal representation program 305 as the internal representation code being the process target;

(b) One or more internal representation codes defined in (a) that follow the internal representation code being the process target;

(c) An internal representation code defined in (b) that has no first type of internal representation code placed between the internal representation code that is a memory access instruction being the process target and itself, the first type of internal representation code being an instruction instructing that the value in a register used by the internal representation code being the process target should be changed.

It is possible to judge whether the internal representation code being the process target and any adjacent internal representation code have a possibility of using mutually the same cache line in the data array 506, by judging, for example, whether the cache line numbers expressed by the values in the base address registers are mutually the same. For example, with regard to the value “0x00010400” in the base address register r1 for the internal representation code 701d, because the cache line number is “04”, one of the cache lines in the data array 506 of which the cache line number is “0-4” is used when the data is accessed. On the other hand, with regard to the value “0x00020400” in the base address register r8 for the internal representation code 701e, because the cache line number is “04”, one of the cache lines in the data array 506 of which the cache line number is “0-4” is used when the data is accessed. In this situation, it is possible to judge that the internal representation code 701e and the internal representation code 701d use mutually the same cache line in the data array 506. However, to judge whether mutually the same cache line in the data array 506 is used, instead of performing the judgment process based on the cache line numbers expressed by the values in the base address registers, it is acceptable to perform the judgment process based on the base address register and an offset register, or based on two or more offset registers.

In a case where there is at least one adjacent representation code being a memory access instruction that uses the same base address register (step S803: Yes), the output program generating unit 303 generates a cache memory access instruction instructing that a plurality of memory accesses should be performed (step S804), and the process proceeds to step S807. In a case where there is no adjacent internal representation code being a memory access instruction that uses the same base address register (step S803: No), the output program generating unit 303 generates a cache memory access instruction instructing that a single memory access should be performed (step S806), and the process proceeds to step S807. At step S807, the output program generating unit 303 proceeds ahead to process the next internal representation code and continues the process starting from step S801.

For example, with the internal representation program 305 shown in FIG. 9, in a case where the internal representation code being the process target is the internal representation code 701c, the output program generating unit 303 generates, based on the internal representation code 701c, a cache memory access instruction instructing that a single memory access should be performed. In a case where the internal representation code being the process target is the internal representation code 701d, the adjacent internal representation code thereof is the internal representation code 701e. Thus, the output program generating unit 303 generates, based on the internal representation codes 701d and 701e, a cache memory access instruction instructing that a plurality of memory accesses should be performed. Also, in a case where the internal representation code being the process target is the internal representation code 701i, the adjacent internal representation code thereof is the internal representation code 701j. Thus, the output program generating unit 303 generates, based on the internal representation codes 701i and 701j, a cache memory access instruction instructing that a plurality of memory accesses should be performed.

The output program that is generated by the output program generating unit 303 is configured so that the processor 401 included in the target computer 102 executes, in parallel, (a) a judgment process (i.e., a cache hit judgment process) of judging whether the data to be accessed has already been stored in the local memory 403 included in the target computer 102 and (b) a copying process (i.e., a pre-loading process) of copying the data stored in the local memory 403 into a register before the cache hit judgment process is completed. In this configuration, the processor 401 included in the target computer 102 executes, in parallel, the pre-loading process and the cache hit judgment process. Thus, the time (i.e., a data access time) it takes for the processor 401 to access the data stored in the local memory 403 is shorter than the time it takes for the processor 401 to access the data by performing a normal loading process after completing the cache hit judgment process. In other words, compared to the case where the processor 401 performs the normal loading process after completing the cache hit judgment process, it is possible to eliminate, from the data access time, the shorter one of the time it takes to perform the pre-loading process and the time it takes to perform the cache hit judgment process.

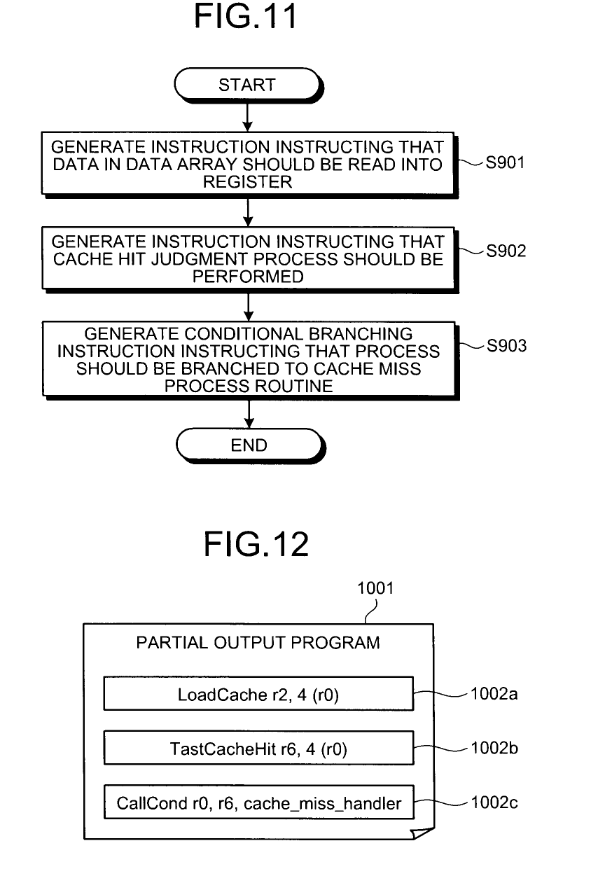

Next, the procedure at step S806 in the process of generating the cache memory access instruction instructing that a single memory access should be performed will be explained. FIG. 11 is a flowchart of the procedure in the process of generating the cache memory access instruction instructing that a single memory access should be performed.

First, by using a main memory address, the output program generating unit 303 generates an instruction (i.e., a load cache instruction) instructing that data in the data array 506 should be read into a register (step S901). Next, the output program generating unit 303 generates an instruction (i.e., a cache hit judgment instruction) instructing that it should be judged whether the data stored at the main memory address is stored in the data array 506 (step S902). Lastly, the output program generating unit 303 generates a conditional branching instruction instructing that, in a case where it has been judged that the data stored at the main memory address is not stored in the data array 506, in other words, in a case where the judgment result indicates that a cache miss has occurred, the process should be branched to a cache miss process routine for performing a cache miss process (step S903). The cache miss process is a process to store (i.e., to copy) the data being the target of the cache hit judgment process into the data array 506.

FIG. 12 is a drawing illustrating an example of a cache memory access instruction that has been generated as a result of the process at step S806. A partial output program 1001 shown in the drawing is a part of the output program 103 and has been generated as a result of processing the internal representation code 701c. An output code 1002a is a first load cache instruction and instructs that the data stored in one of the cache lines in the data array 506 that corresponds to an address in the main memory 406 that is obtained by adding an offset value to a base address register value should be loaded. More specifically, the output code 1002a instructs that the data should be loaded from an address within the data array 506 obtained by adding an offset value “4” to the value in the register r0, which is a base address register, and should be set into the register r2. In this situation, according to the load cache instruction, the process can be continued in parallel with a following instruction, and the following instruction can be executed even if the process has not been completed. According to the present embodiment, the load cache instruction is written in a single machine language; however, another arrangement is acceptable in which the same functions are realized by a combination of a plurality of machine languages.

An output code 1002b is a first cache hit judgment instruction and instructs that it should be judged whether the data stored at an address within the main memory 406 obtained by adding an offset value to a base address register value is stored in the corresponding one of the cache lines in the data array 506, and that the judgment result should be set into a specified register. More specifically, the output code 1002b instructs that it should be judged whether the data stored at the address obtained by adding an offset value “4” to the value in the register r0, which is a base address register value, is stored in the corresponding one of the cache lines in the data array 506, and that “0” should be set into a register r6 if the data is stored, and “1” should be set into the register r6, if the data is not stored. According to the present embodiment, the cache hit judgment instruction is written in a single machine language; however, another arrangement is acceptable in which the same functions are realized by a combination of a plurality of machine languages.

An output code 1002c is a conditional branching instruction and instructs that, in a case where the value in a conditional register is “1”, the address of a following instruction should be set into a return address register so that the process branches to a specified address. More specifically, the output code 1002c instructs that, in a case where the value in the register 6, which is a conditional register, is “1”, the address of the following instruction should be set into the register r0, which is a return address register, so that the process branches to the specified address expressed as “cache_miss_handler”. The address “cache_miss_handler” is an address for the cache miss process routine.

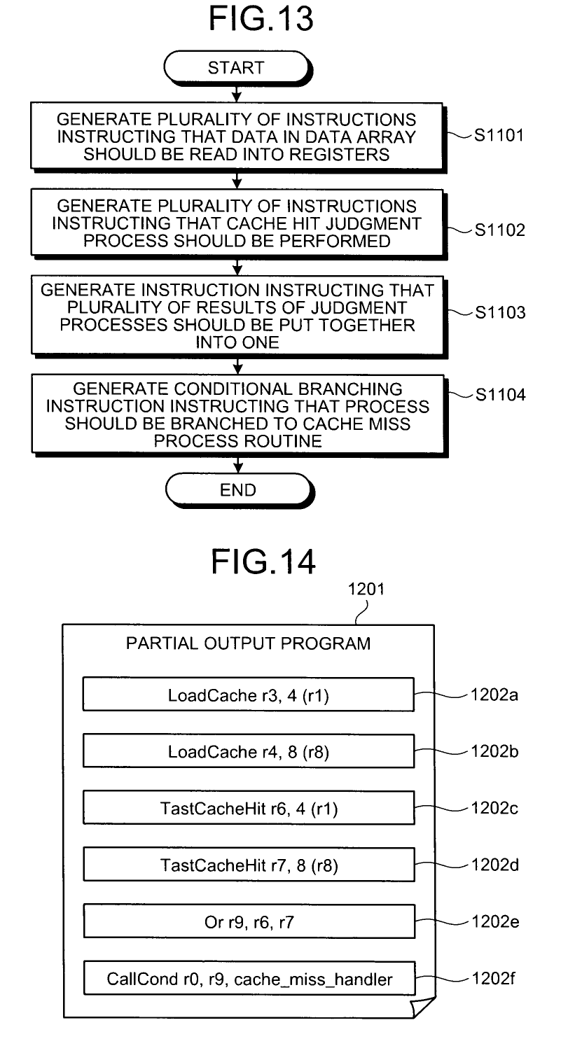

Next, a procedure in the process at step S804 to generate the cache memory access instruction instructing that a plurality of memory accesses should be performed will be explained. FIG. 13 is a flowchart of the procedure in the process of generating the cache memory access instruction instructing that a plurality of memory accesses should be performed.

First, with respect to all the memory access instructions being the targets, the output program generating unit 303 generates, by using each of the main memory addresses, a plurality of instructions (i.e., load cache instructions) instructing that the data stored in the data array 506 should be read into registers (step S1101). Next, with respect to all the memory access instructions being the targets, the output program generating unit 303 generates a plurality of instructions (i.e., cache hit judgment instructions) instructing that it should be judged whether the data stored at the main memory addresses is stored in the data array 506 (step S1102). Further, the output program generating unit 303 generates an instruction instructing that a plurality of judgment results should be combined into one judgment result (step S1103). Lastly, the output program generating unit 303 generates a conditional branching instruction instructing that, in a case where the judgment result indicates that a cache miss has occurred, the process should be branched to the cache miss process routine (step S1104).

FIG. 14 is a drawing illustrating an example of the cache memory access instruction that has been generated as a result of the process at step S804. A partial output program 1201 shown in the drawing is a part of the output program 103 and has been generated as a result of processing the internal representation codes 701d and 701e. An output code 1202a is a first load cache instruction and instructs that the data should be loaded from an address within the data array 506 obtained by adding an offset value “4” to the value in the register r1, which is a base address register, and should be set into the register r3.

An output code 1202b is a first load cache instruction and instructs that the data should be loaded from an address within the data array 506 obtained by adding an offset value “8” to the value in the register r8, which is a base address register, and should be set into the register r4.

An output code 1202c is a first cache hit judgment instruction and instructs that it should be judged whether the data at the address obtained by adding an offset value “4” to the value in the register r1, which is a base address register, is stored in a corresponding one of the cache lines in the data array 506 and that “0” should be set into the register r6 if the data is stored, and “1” should be set into the register r6 if the data is not stored.

An output code 1202d is a first cache hit judgment instruction and instructs that it should be judged whether the data at the address obtained by adding an offset value “8” to the value in the register r8, which is a base address register, is stored in a corresponding one of the cache lines in the data array 506 and that “0” should be set into a register r7 if the data is stored, and “1” should be set into the register r7 if the data is not stored.

An output code 1202e is an example in which a logical OR instruction is used as a combine instruction instructing that a plurality of judgment results should be combined into one judgment result. The output code 1202e instructs that a logical OR of the value in the register r6 and the value in the register r7 should be calculated and that the result of the calculation should be set into the register r9.

An output code 1202f instructs that, in the case where the value in the register r9, which is a conditional register, is “1”, the address of the following instruction should be set into the register r0, which is a return address register, and that the process should be branched to the specified address expressed as “cache_miss_handler”.

As explained above, the output program generating unit 303 puts the instructions into one partial output program 1201, the instructions including the output code 1202e instructing that the judgment results of the cache hit judgment instructions (i.e., the output codes 1202c and 1202d in the present example) with respect to the plurality of memory access instructions (i.e., the output codes 1202a and 1202b in the present example) having a possibility of causing accesses to mutually the same cache line should be combined into one judgment result and the instruction that the cache miss process should be performed according to the combined judgment result.

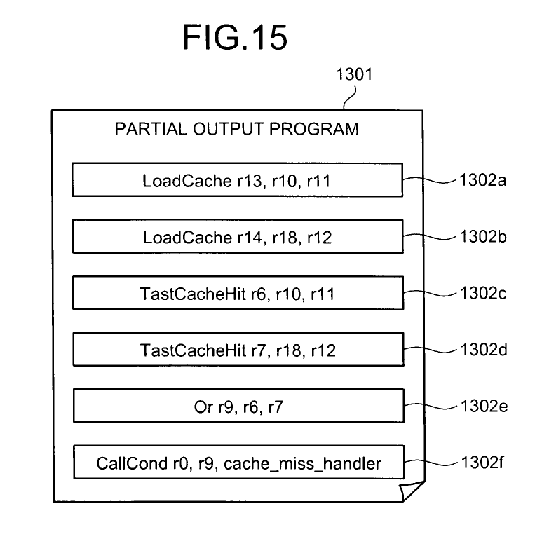

Another example of a cache memory access instruction that has been generated as a result of the process at step S804 will be explained. FIG. 15 is a drawing illustrating another example of a cache memory access instruction that has been generated as a result of the process at step S804. A partial output program 1301 shown in the drawing is a part of the output program 103 and has been generated as a result of processing the internal representation codes 701i and 701j.

An output code 1302a and an output code 1302b are each a second load cache instruction instructing that the data stored in one of the cache lines in the data array 506 that corresponds to an address in the main memory 406 obtained by adding an offset register value to a base address register value should be loaded. More specifically, the output code 1302a instructs that the data should be loaded from an address within the data array 506 obtained by adding the value in the register r11, which is an offset register, to the value in the register r10, which is a base address register, and should be set into the register r13. The output code 1302b instructs that the data should be loaded from an address within the data array 506 obtained by adding the value in a register r12, which is an offset register, to the value in the register r18, which is a base address register, and should be set into the register r14.

An output code 1302c and an output code 1302d are each a second cache hit judgment instruction instructing that it should be judged whether the data stored at an address within the main memory 406 obtained by adding an offset register value to a base address register value is stored in a corresponding one of the cache lines in the data array 506 and that the judgment result should be set into a specified register. More specifically, the output code 1302c instructs that it should be judged whether the data stored at the address obtained by adding the value in the register r11, which is an offset register, to the value in the register r10, which is a base address register, is stored in a corresponding one of the cache lines in the data array 506, and that “0” should be set into the register r6 if the data is stored, and “1” should be set into the register r6, if the data is not stored. The output code 1302d instructs that it should be judged whether the data stored at the address obtained by adding the value in the register r12, which is an offset register, to the value in the register r18, which is a base address register, is stored in a corresponding one of the cache lines in the data array 506, and that “0” should be set into the register r7 if the data is stored, and “1” should be set into the register r7, if the data is not stored.

An output code 1302e is an example in which a logical OR instruction is used as a combine instruction instructing that a plurality of judgment results should be combined into one judgment result. The output code 1302e instructs that a logical OR of the value in the register r6 and the value in the register r7 should be calculated and that the result of the calculation should be set into the register r9. An output code 1302f instructs that, in the case where the value in the register r9, which is a conditional register, is “1”, the address of the following instruction should be set into the register r0, which is a return address register, and that the process should be branched to the specified address expressed as “cache_miss_handler”.

As explained above, the output program generating unit 303 analyzes the internal representation program 305 and generates the output program 103 that contains the various types of instructions, so as to generate the output program 103 from the internal representation program 305. The output program 103 is output to the target computer 102 via the output program output device 205. The target computer 102 inputs the output program 103 to the local memory 403 via the output program input device 409. Subsequently, the processor 401 included in the target computer 102 reads the output program 103 from the local memory 403 when executing the output program 103. As explained above, the output program 103 contains operation instructions in addition to the load cache instructions and the cache hit judgment instructions that correspond to the memory access instructions. Accordingly, the processor 401 performs the processes according to the various types of instructions that are contained in the output program 103.

Next, a procedure in a process that is performed when the processor 401 included in the target computer 102 executes the output program 103 will be explained. The processor 401 executes the output program 103 stored in the local memory 403, and also executes a cache data controlling program. Thus, when performing a process according to a memory access instruction contained in the output program 103, the processor 401 executes, in parallel, the cache hit judgment process and the pre-loading process according to the cache data controlling program.

Next, an operation performed by the processor 401 according to the partial output program 1201 included in the output program 103 that is shown in FIG. 14 will be more specifically explained. For example, in a case where the data stored at the address “0x00010400” in the main memory 406 is temporarily stored in one of the cache lines in the data array 506 of which the cache line number is “0-4”, if the processor 401 loads the data in the corresponding one of the cache lines in the data array 506 into the register r3 according to a first load cache instruction (i.e., the output code 1202a) that corresponds to the internal representation code 701d, the correct data being the process target is loaded into the register r3. Thus, when the processor 401 performs a cache hit judgment process according to a first cache hit judgment instruction based on the output code 1202c, the processor 401 judges that a cache hit has occurred and records “0” into the register r6. On the other hand, when the processor 401 loads the data in the corresponding one of the cache lines in the data array 506 into the register r4 according to a first load cache instruction (i.e., the output code 1202b) that corresponds to the internal representation code 701e, wrong data that is not a process target is loaded into the register r4. Thus, when the processor 401 performs a cache hit judgment process according to a first cache hit judgment instruction based on the output code 1202d, the processor 401 judges that a cache miss has occurred and records “1” into the register r7. After that, according to a combine instruction based on the output code 1202e, the processor 401 calculates a logical OR of the value “0” in the register r6 and the value “1” in the register r7 and sets “1” into the register r9. Lastly, the processor 401 performs a process according to a conditional branching instruction based on the output code 1202f, and the process branches to a specified address expressed as “cache_miss_handler”. The processor 401 then performs a cache miss process that corresponds to the load cache instruction (i.e., the output code 1202b) that has caused a judgment result indicating that a cache miss has occurred.

Of the memory access instructions that cause accesses to mutually different cache lines in the main memory 406, when two cache hit judgment processes are respectively performed with respect to the two memory access instructions having a possibility of causing accesses to mutually the same cache line in the data array 506, according to the conventional technique, there is a possibility that the number of times a judgment result indicating that a cache miss has occurred is output may be two; however, according to the present embodiment, it is possible to reduce the number of times such a judgment result is output to one. Consequently, it is possible to reduce the number of times the cache miss process needs to be performed.

To perform the cache miss process, the processor 401 controls the data transfer device 405 so that the data specified by a main memory address is transferred from the main memory 406 to the local memory 403 and copies the data into one of the cache lines in the local memory 403 that corresponds to the line number of the main memory address for the data. After that, the processor 401 performs a process (i.e., a load process) of copying the data that has been copied in the local memory 403 into one of the registers included in the register file 408.

In this situation, the value in the register r8 that is the base address register for the first load cache instruction (i.e., the output code 1202b) that has caused the judgment result indicating that a cache miss has occurred is “0x00020400”. Thus, as a result of the cache miss process, instead of the data stored at the address “0x00010400” in the main memory 406, the data stored at the address “0x00020400” in the main memory 406 is temporarily stored in one of the cache lines in the data array 506 of which the cache line number is “0-4”. Accordingly, in a case where a loop process is performed so that the partial output program 1202 is repeatedly executed, when the processor 401 executes the partial output program 1201 next time and loads data according to the first load cache instruction based on the output code 1202a, the processor 401 performs a cache hit judgment process according to the first cache hit judgment instruction based on the output code 1202c and judges that a cache miss has occurred. On the other hand, when the processor 401 loads data according to the first load cache instruction based on the output code 1202b, the processor 401 performs a judgment process according to the first cache hit judgment instruction based on the output code 1202d and judges that a cache hit has occurred.

In this situation also, of the memory access instructions that cause accesses to mutually different cache lines in the main memory 406, when two cache hit judgment processes are performed with respect to the two memory access instruction having a possibility of causing accesses to mutually the same cache line in the data array 506, it is possible to reduce the number of times a judgment result indicating that a cache miss has occurred is output to one. In contrast, according to the conventional technique, the number of times such a judgment result is output may be two.

In other words, when the loop process is performed so that the partial output program 1201 is repeatedly executed, even if the pre-loading process and the cache hit judgment process corresponding to the internal representation code 701d and the pre-loading process and the cache hit judgment process corresponding to the internal representation code 701e are executed alternately, it is possible to reduce the number of times a judgment result indicating that a cache miss has occurred is output in each loop process.

In addition, when the processor 401 executes the partial output program 1301, with respect to two memory access instructions, it is also possible to reduce the number of times a judgment result indicating that a cache miss has occurred is output to one, like in the example where the processor 401 executes the partial output program 1201.

As explained above, it is possible to reduce the number of times the judgment process needs to be performed for judging whether a cache miss process needs to be performed, by combining the judgment results of the cache hit judgment processes into one judgment result, the cache hit judgment processes being performed with respect to the plurality of memory access instructions having a possibility of using mutually the same cache lines in the cache memory, when mutually different cache lines in the main memory are accessed. As a result, because the cache miss process is performed according to the combined judgment result, it is possible to reduce the number of times the cache miss process needs to be performed. Consequently, it is possible to inhibit occurrence of thrashing and also to prevent the level of data supply performance of the memories from being lowered.

A person skilled in the art will be easily able to conceive other advantageous effects and modification examples. Thus, other modes of the present invention having a wider scope are not limited by the specific details and the exemplary embodiments of the present invention that are explained and described above. Accordingly, it is possible to modify the present invention in various manners without departing from the spirit or the scope of the general inventive concept as defined by the appended claims and the equivalents thereof.

An arrangement is acceptable in which one or both of the program conversion program executed by the host computer 101 and the cache data controlling program executed by the target computer 102 according to the embodiment described above are stored in a computer connected to a network such as the Internet and are provided as being downloaded via the network. Another arrangement is also acceptable in which one or both of the programs are provided as being set on a computer-readable recording medium such as a CD-ROM, a flexible disk (FD), a CD-R, or a Digital Versatile Disk (DVD), in a file in an installable format or in an executable format.

In the description of the exemplary embodiments above, an example is used in which the number of memory access instructions that have a possibility of using mutually the same cache line in the local memory 403 when the data stored in the different cache line in the main memory 406 is accessed is two; however, the present embodiment is not limited to this number.

Also, the correspondence relationships among the main memory addresses in the main memory 406, the cache lines in the main memory 406, and the cache lines in the local memory 403 are not limited to the example described above.

In the description of the exemplary embodiments above, the host computer 101 and the target computer 102 are configured as two separate elements; however, another arrangement is acceptable in which at least one of the host computer 101 and the target computer 102 has the functions of the other as described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a program converting unit that converts a first program containing at least one instruction into a second program executable by a first information processing apparatus that includes a processor, a main memory, and a cache memory, the processor having a register operable to temporarily store data used while a program is executed, the main memory being divided in units of cache lines and being operable to store a plurality of pieces of the data into first cache lines that respectively correspond to addresses of pieces of the data, and the cache memory being divided in units of cache lines and in which at least one of second cache lines is used while the data is accessed; and
an output unit that outputs the second program, wherein the program converting unit includes:
a first instruction generating unit that generates a load cache instruction that represents an instruction to transfer to the register, stored data stored in at least one of the second cache lines used in correspondence with the first cache lines storing the data, with respect to a memory access instruction that is a instruction contained in the first program and represents an instruction to access to the data;
a second instruction generating unit that generates a cache hit judgment instruction that represents an instruction to judge whether the data is stored in at least one of the second cache lines being used in correspondence with the first cache lines storing the data, with respect to the memory access instruction; and
a third instruction generating unit that generates a combine instruction instructing that judgment results obtained according to the cache hit judgment instructions generated with respect to the memory access instructions are combined into one judgment result, when the first program contains a plurality of memory access instructions having a possibility of using a mutually same second cache line while pieces of the data stored in mutually different first cache lines are accessed.

2. The apparatus according to claim 1, wherein
each of the memory access instructions is a memory access instruction with a first register indirect addressing mode in which each of the addresses within the main memory of the data is calculated by adding a constant value to a value in a first register indicating a base address, and
the third instruction generating unit generates the combine instruction when the first program contains the plurality of memory access instructions that use mutually the same second cache line being used in correspondence with the first cache line that corresponds to the base address indicated by the first register.

3. The apparatus according to claim 1, wherein
each of the memory access instructions is a memory access instruction with a second register indirect addressing mode in which each of the addresses of the data within the main memory is calculated by adding a value in a first register and a value in a second register together, and
the third instruction generating unit generates the combine instruction when it is judged that the first program contains the plurality of memory access instructions that use mutually the same second cache line while the pieces of data stored in the mutually different first cache lines are accessed, based on at least one of the value in the first register and the value in the second register.

4. The apparatus according to claim 1, wherein the third instruction generating unit generates as the combine instruction an instruction to obtain a logical OR of the judgment results, when the first program contains the plurality of memory access instructions having the possibility of using mutually the same second cache line while the pieces of data stored in the mutually different first cache lines are accessed.

5. The apparatus according to claim 1, wherein the program converting unit further includes a fourth instruction generating unit that generates a cache miss instruction representing an instruction to transfer the data from the main memory to the cache memory by using an address in the main memory, and subsequently transfer the data from the cache memory to the register, when either the judgment results obtained according to the cache hit judgment instructions or the combined judgment result obtained according to the combine instruction indicates that the data is not stored in at least one of the second cache lines.

6. The apparatus according to claim 5, wherein the program converting unit generates the second program that contains the load cache instruction, the cache hit judgment instruction, the combine instruction, and the cache miss instruction.

7. The apparatus according to claim 1, wherein the third instruction generating unit judges whether the basic block contains a plurality of memory instructions having a possibility of using mutually same second cache line, for each of basic blocks obtained by dividing the first program in units of predetermined processes while the pieces of data stored in the mutually different first cache lines are accessed, and generates the combine instruction when a judgment result is affirmative.

8. The apparatus according to claim 1, wherein the first program is a program written in a high-level programming language.

9. The apparatus according to claim 1, wherein the first program is a program written in a machine language that is interpretable by another processor different from the processor.

10. The apparatus according to claim 1, wherein the second program is a program written in a machine language that is interpretable by the processor.

11. An information processing apparatus comprising:
a processor having a register operable to temporarily store data used while a program is executed;
a main memory that is divided in units of cache lines and is operable to store a plurality of pieces of the data into first cache lines that respectively correspond to addresses of the pieces of data;
a local memory that is divided in units of cache lines and in which at least one of second cache lines is used while the data is accessed;
a transfer unit that transfers the data stored in the main memory to the local memory; and
a cache data controlling unit that performs a judgment process of judging whether the data is stored in the local memory when the processor accesses the data while executing the program, and also performs, before completing the judgment process, a transfer process of transferring to the register, stored data stored in a memory area within the local memory being used while the data is accessed, wherein
the cache data controlling unit performs the judgment process and the transfer process in parallel that are performed with respect to a plurality of pieces of the data,
the cache data controlling unit combines results of judgment processes performed with respect to the plurality of pieces of the data into one judgment result, when there is a possibility that a mutually same second cache line may be used while a plurality of pieces of the data stored in mutually different first cache lines are accessed, and
the cache data controlling unit causes the transfer unit to transfer the data from the main memory to the local memory according to the combined judgment result, and subsequently performs a second transfer process of transferring the data from the local memory to the register.

12. An information processing apparatus comprising:
a processor having a register operable to temporarily store data used while a program is executed;
a main memory that is divided in units of cache lines and is operable to store a plurality of pieces of the data into first cache lines that respectively correspond to addresses of the pieces of data;
a local memory that is divided in units of cache lines and in which at least one of second cache lines is used while the data is accessed;
a program converting unit that converts a first program containing at least one instruction into a second program that is executable by the processor; and
a cache data controlling unit that performs a judgment process of judging whether the data is stored in the local memory, when the processor accesses the data while executing the second program, and also performs, before completing the judgment process, a transfer process of transferring to the register, stored data stored in a memory area within the local memory being used while the data is accessed, wherein
the program converting unit includes a first instruction generating unit, a second instruction generating unit, and a third instruction generation unit and generates the second program that contains at least a load cache instruction and a cache hit judgment instruction, the first instruction generating unit being operable to generate a load cache instruction that represents an instruction to transfer to the register, stored data stored in at least one of the second cache lines used in correspondence with the first cache lines storing the data; the second instruction generation unit being operable to generate the cache hit judgment instruction that represents an instruction to judge whether the data is stored in at least one of the second cache lines being used in correspondence with the first cache lines storing the data, with respect to a memory access instruction; and the third instruction generating unit being operable to generate a combine instruction instructing that judgment results obtained according to the cache hit judgment instructions generated with respect to the memory access instructions are combined into one judgment result, when the first program contains a plurality of memory access instructions having a possibility of using a mutually same second cache line while pieces of the data stored in mutually different first cache lines are accessed,
the cache data controlling unit performs the judgment process and the transfer process in parallel that are performed with respect to a plurality of pieces of the data,
the cache data controlling unit combines results of judgment processes that are performed with respect to the plurality of pieces of the data into one judgment result, when there is a possibility that a mutually same second cache line is used while a plurality of pieces of the data stored in mutually different first cache lines are accessed, and
the cache data controlling unit causes a transfer unit to transfer the data from the main memory to the local memory according to the combined judgment result, and subsequently performs a second transfer process of transferring the data from the local memory to the register.
